(19) United States
(12) Patent Application Publication
(10) Pub. No.: US 2008/0071444 A1
(43) Pub. Date: Mar. 20, 2008

(54) Device having a camera and method thereof

(75) Inventor: Garth D. Hillman, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Advanced Micro Devices, Inc., Sunnyvale, CA (US)

(21) Appl. No.: 11/521,859

(22) Filed: Sep. 15, 2006

(51) Int. Cl. G06F 7/00

(52) U.S. Cl. 701/36

(57) ABSTRACT

A device is disclosed that comprises a passenger vehicle having a camera wirelessly communicating with a wireless router 121. The device communicates wirelessly to provide information using Internet Protocol (IP). The wireless connection is compliant with a standard, such as 802.11x, G3, G4, or 802.16x, and is part of a local area network. Image information is requested from and provided by the camera.

### FIELD OF THE DISCLOSURE

The present disclosure relates generally to devices having a camera, and more particularly to a passenger vehicle having a camera.

### BACKGROUND

Security systems are known to be employed in passenger vehicles to prevent theft and damage to the vehicle. One type of security system allows for the user to selectively enable a panic siren if a threatening situation is encountered. Such panic systems are prone to unintentional activation, and typically require a user to be close to the threatening situation prior to being activated. Therefore, the ability for a user to monitor a security status of a passenger vehicle remotely would be useful.

### BRIEF DESCRIPTION OF THE DRAWINGS

The present disclosure may be better understood, and its numerous features and advantages made apparent to those skilled in the art by referencing the accompanying drawings.

FIG. 1 includes a representation of a wireless communications link between a passenger vehicle and a wireless router in accordance with the present disclosure.

FIG. 2 includes an illustration of a specific embodiment of a portion of a device of FIG. 1.

FIG. 3 includes an illustration representing two devices in wireless communication with one or more wireless routers in accordance with the present disclosure.

FIGS. 4-7 include illustrations in flow diagram form of specific embodiments in accordance with the present disclosure.

FIG. 8 includes illustrations of devices in communication with wireless routers in accordance with another embodiment of the present disclosure.

FIG. 9 includes illustrations in flow diagram form of a method of a specific embodiment of the present disclosure.

The use of the same reference symbols in different drawings indicates similar or identical items.

### DESCRIPTION OF THE PREFERRED EMBODIMENT(S)

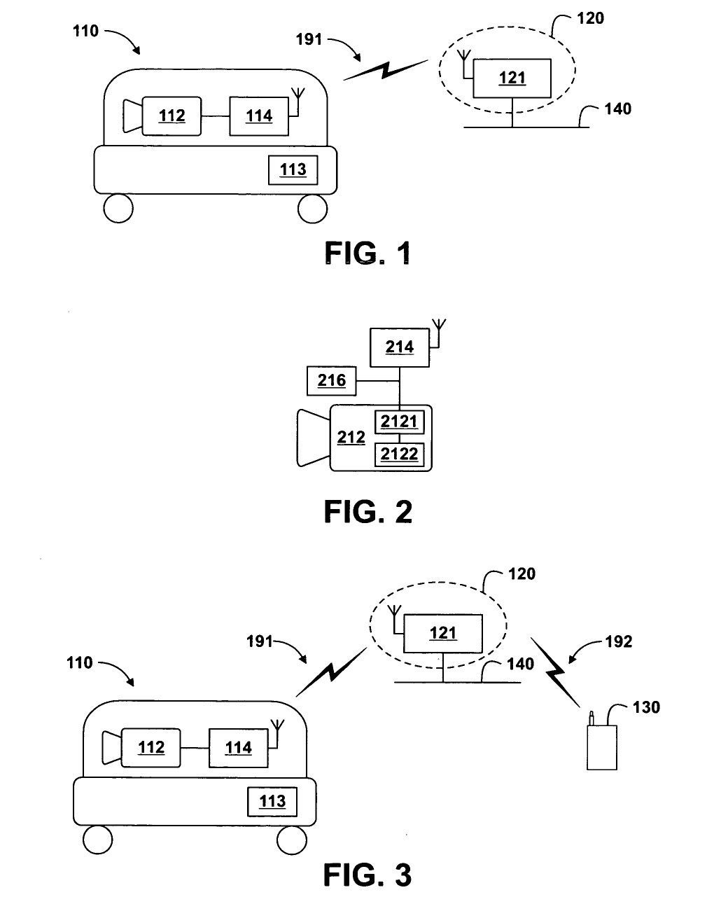

FIG. 1 illustrates a device 10 that comprises a passenger vehicle having a camera 112 wirelessly communicating with a wireless router 121 to support an IP-based (Internet Protocol) connection. In accordance with a specific embodiment of the present disclosure, the device 110 communicates wirelessly to associate with the wireless router 121 through wireless connection 191 and a subsequent authentication occurs that assigns an IP address to the device 110. In accordance with a specific embodiment of the present disclosure, the wireless connection 191 is compliant with a standard, such as 802.11x, 3G, 4G, or 802.16x, and is part of a local area network. In a specific embodiment, the passenger vehicle can be a car, bus, motorcycle, or other land-based motor vehicles. In addition, the passenger vehicle can be a water-based motor vehicle, such as a boat or other passenger vehicle that is in range of a local area network.

Camera 112 is illustrated as being connected to a wireless IP-based communications controller 114. The wireless IP-based communications controller communicates with the wireless router 121 to provide information over the wireless connection 191. It will be appreciated, that the wireless communications controller 114 can be integrated within the camera 112, or be separate from the camera 112. In addition, a power supply 113 is illustrated that is a portion of the motor vehicle, such as the motor vehicle's battery. In one embodiment, the camera 112 and controller 114 are powered from a power supply 113. It is also possible for a power supply other than power supply 113 to power the camera 112 and controller 114. The camera 112 includes a communications interface (not specifically illustrated in FIG. 1) to receive remote requests from communications controller 114, through which the camera 112 obtains requests to obtain and provide images for transmission over the wireless communications link 191 for a requesting device.

The wireless router 121 includes wireless router functionality and attaches to wireless 802.11 stations, such as device 110, and to a backbone distribution network 140. In one embodiment, the backbone distribution network 140 is a wired network, though in other embodiments, the backbone distribution network 140 may also be a wireless distribution network.

The wireless router 121 is a member of a service set 120. As used herein, the term service set means either a basic service set, an extended service set, or a meshed service set. A basic service set is a single access point that is not tied to other access points to provide roaming of stations. An extended service set is a logical collection of access points all tied together. A meshed service set is a logical collection of access points all tied together capable of routing a message between two access points of the meshed service set via more that one set of access points within the meshed service set. Within an extended service set, link layer roaming is possible throughout, provided the stations that are members of the extended service set are configured to recognize each other. Operation of the system illustrated in FIG. 1 will be discussed with reference to the methods herein.

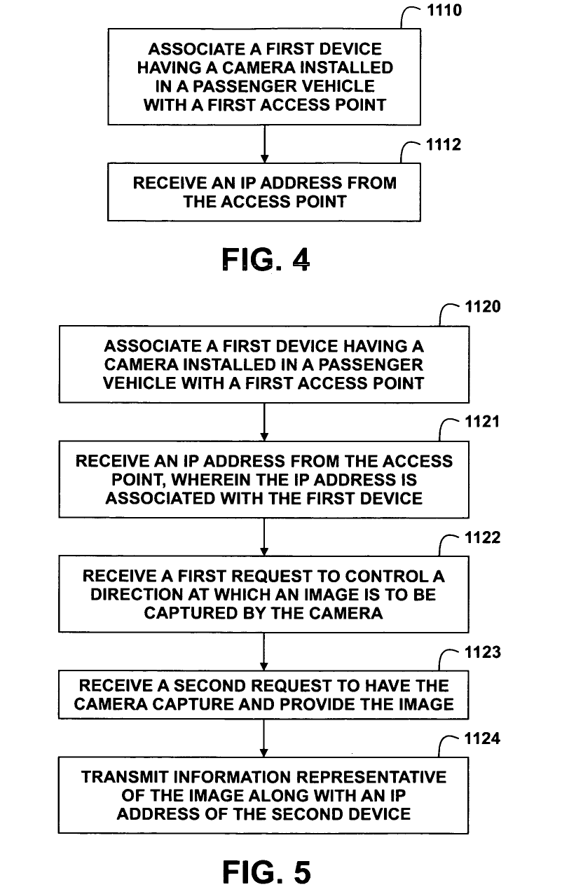

FIG. 2 illustrates a specific embodiment of a portion of device 110. Specifically, FIG. 2 illustrates a camera 212, a wireless IP-based communications controller 214, and a control module 216. The camera 112 and the control module 216 are connected to the wireless communications controller 214 to receive remote requests for information through the wireless communications controller 214 that control the direction at which the camera 112 is to take a picture. For example, the control module 216 can have a communications interface (not illustrated) to receive information that is received wirelessly over the wireless connection 191 to control a direction at which camera 212 is to obtain a picture. Similarly, the camera 212 has a communications interface 2121 that receives instructions indicating when the camera 212 is to take a picture and provide the picture to the communications controller 214 for transmission. In addition, the camera 212 includes a control module 2122 connected to the communications interface 2121. Control module 2122 processes requests received from communication interface controller 2121 from remote devices, which would include requests to obtain and provide information, such as image formation.

Similarly, control module 216 receives remote requests to control a direction that camera 212 obtains a picture. In one embodiment, control module 216 would include the control software and hardware necessary to physically rotate the camera 212 to point in desired direction. Alternatively, the control module 216 can control the direction that a picture is obtained using non-mechanical means. For example, camera 112 can have a plurality of lenses selectable by control module 216. Therefore, the control module 216 is used to determine a proximate area near the camera 112 at which a picture is to be taken.

In accordance with a specific embodiment, the wireless IP-based communications controller 214 is identified by wireless router 121 by an IP address that is unique to the wireless router. The access point sends information to the wireless IP-based communications controller 214 using IP packets that include the IP address of the controller 214. Once information is received from the wireless router 121, the wireless communications controller 214 would provide information within the packet to one or more communications interfaces at the camera 212 and control module 216 for further processing.

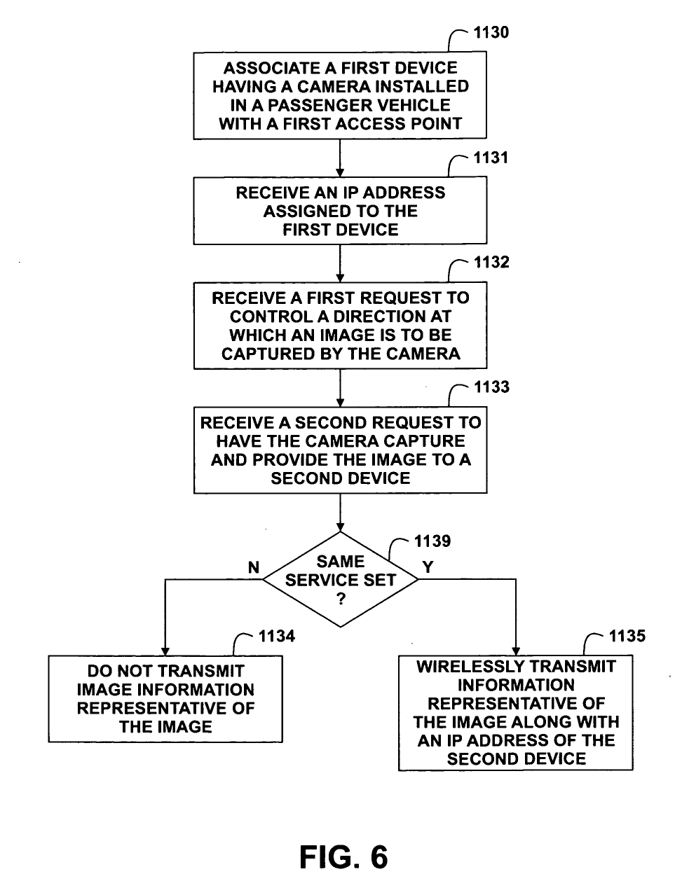

FIG. 3 illustrates a system in accordance with another embodiment of the present disclosure. The elements of FIG. 3 that are similarly numbered as elements in FIG. 1 represent elements having the same functionality as the element previously discussed. In addition, FIG. 3 includes a communications link 192 between a device 130 and the service set 120. The device 130 represents a mobile wireless device such as a personal data assistant (PDA) or other IP based device. Alternatively, the device 130 may be a wired IP-based device connected to the backbone 140 to which the service set 120 is also connected. In accordance with a specific embodiment of the present disclosure, the device 110 will only provide video information through the wireless link 191 if the request for the video information came from the device 130. Therefore, device 110 needs to authenticate a request for information is from device 130. Such authentication is can be accomplished using password schemes, public/private keys, device identification information, and the like.

In one embodiment, the initiating device, device 130, needs to be a member of the same service set as the destination device, device 110, in order for the device 110 to provide the requested information. Requiring an initiating device and a destination device to be members of a common service set allows the owner of an establishment, such as a retail establishment or sports facility, to provide a service to its customers that are on premises. For example, a mall could provide a service whereby customers can remotely monitor their vehicles through a service set provided by the mall as long as they are physically located at the mall, i.e. within the service set provided by the mall. Requiring an initiating device and a destination device to be in the same service set, or specific service sets, can also help assure that the camera mounted within a motor vehicle of a customer is not be accessed from unauthorized individuals. For example, the device 110 or access point 121 can determine whether or not an initiating device is a member of the same extended service set prior to providing image information. If so, the image information can be provided. If not, the device 112 will not provide the information.

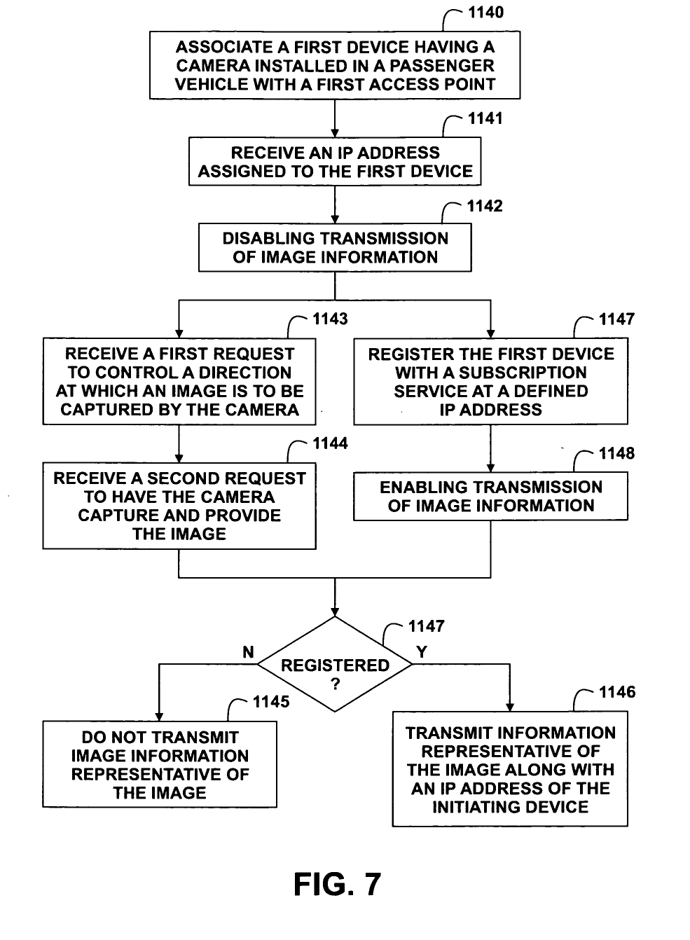

FIG. 4 illustrates in flow diagram form a method in accordance with the present disclosure. At step 1110, a first device that includes a camera installed in a passenger vehicle is associated with a first wireless router in response to entering the coverage area of the first wireless router. Once associated with the wireless router, an authentication procedure occurs that allows an IP address to be assigned by the wireless router to the first device. In accordance with a specific embodiment of the disclosure, the association of the first device with the wireless router is done according to the 802.11 standard, and assignment of the IP address is accomplished according to the TCP/IP protocol.

FIG. 5 illustrates, in flow diagram form, a method in accordance with the present disclosure. Block 1120 corresponds to block 1110 of FIG. 4, which associates the first device with a wireless router. Block 1121 corresponds to block 1111 of FIG. 4 where an IP address is received at the first device from the wireless router. Block 1122 indicates that information is received that includes a first request to control a direction from which an image is to be captured by a camera as previously discussed. The direction can be controlled by physically moving the camera or selecting a specific lens in one embodiment, the requests must originate from an initiating device within the same service set to be honored. In an alternate embodiment, requests can only be honored by the destination device, i.e., the camera, after the destination device has been registered with a subscription service as will be discussed further herein. Alternatively, the destination device can honor a request to provide information provided the request is authenticated, such as through the use of a password or other identification that allows verification that a request is from an authorized device.

At block 1123, a second request is received to have the camera capture and provide an image. As previously discussed, the image would be provided via a wireless communications link to an wireless router and further provided from the wireless router to a destination device.

At 1124, image information representative of the image captured at 1123 is transmitted along with an IP address of the second device. In one embodiment, the second device can be the initiating device, such as the handheld device 130 illustrated in FIG. 3. In this manner, an owner of a passenger vehicle can use a TCP/IP connection to determine whether or not the area proximate the passenger vehicle is currently secure based upon a received image. Furthermore, by controlling a direction of the camera and receiving an image from the camera mounted within the passenger vehicle, an owner of the passenger vehicle can make a determination from a safe distance whether or not their motor vehicle is currently secure.

FIG. 6 illustrates, in flow diagram form, a method in accordance with an alternate embodiment of the present disclosure. In FIG. 6, blocks 1130-1133 correspond to previously described operations at corresponding blocks 1120-1123, respectively, of FIG. 5. At block 1139, a determination is made whether or not the destination device, e.g., the passenger vehicle having the camera, is within the same service set as the initiating device, such as a handheld PDA device. If so, the flow proceeds to 1135 where the image information is wirelessly transmitted from the destination device along with the IP address of the initiating device. In this manner, the request to have the camera capture and provide an image at 1133 is honored. However, if it is determined at 1139 that the second request came from a requesting device that is not a station within the same service set as the destination device, the flow of the method of FIG. 6 proceeds to 1134. At block 1134 the request to transfer image information is not honored. It will be appreciated, that an initiating device is a device at which the request to capture and provide the image originates. Therefore, with respect to FIG. 3, the initiating device would be device 130, which would be used by an owner of the motor vehicle of device 110 to cause a request to be generated and transmitted over the wireless communications link 192 to an wireless router within the service set 120 for delivery to device 110. It will be appreciated that in addition to using a service set identifier to limit access to information, keys can be used to provide access to the access points of the services set as well as to the device 110 which can require authorization of a key prior to providing requested information.

FIG. 7 illustrates, in flow diagram form, a method in accordance with another embodiment of the present disclosure. Blocks 1140 and 1141 correspond to previously described operations at blocks 1130 and 1131, respectively, of FIG. 6 as previously discussed. After disabling transmission at block 1142, parallel paths occur. Along a first path, which includes blocks 1147 and 1148, the device including the camera can register with a subscription service. The subscription service can be accessed over the Internet at a defined IP address, or can be a subscription service provided by an owner of the facility, such as a mall, where the device that includes the camera is located. Registering with the subscription service will allow the service to know how to access the camera within device 110 using the TCP/IP protocol to obtain images from the camera. For example, where the subscription service is not specifically associated with a specific facility, the device containing the camera would provide its IP address as part of the registration process with the subscription service. In this manner, the subscription service would know where to send requests to receive images from a registered device. Once registered, flow proceeds to block 1148 whereby transmission of image information from the device that includes the camera is enabled. Along a second path that is parallel to the first path, flow will proceed to block 1143. Note, in one embodiment subscribing to a service is necessary to fully access functionality of the camera

At block 1143, a request is received to control the direction at which the camera image is to be captured. At block 1144, a second request is received to have the camera capture and provide an image. At block 1147, a determination is made whether or not the camera of device 110 has been enabled to transmit information. Therefore, if the device has not yet been registered at block 1147, flow will proceed to block 1145 whereby requests to provide image information will not be honored. However, provided the camera has been registered at block 1147, flow will proceed to block 1146 whereby requests for image information will be honored allowing the image to be transmitted along with an IP address of the destination device.

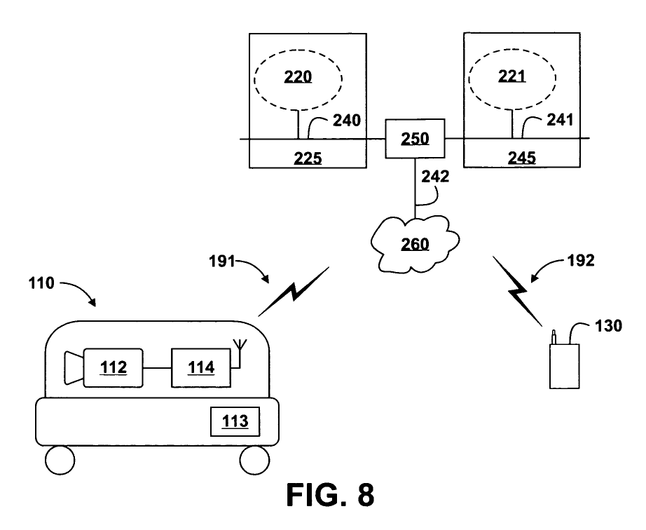

FIG. 8 illustrates an alternate embodiment of a system in accordance with the present disclosure. FIG. 8 illustrates a first service set 220 that corresponds generally to the service set 120 previously described. The service set 220 services a physical area represented by the block 225. In one embodiment block 225 would include the parking lot of a commercial establishment, or sporting arena. A second service set 221 provides wireless coverage to a second area 245. The second area 245 can represent an area inside a commercial establishment such as a mall or within a sporting area itself. The two service sets 220 and 221, which would typically be extended service sets, are both connected to a server 250. The server 250 is further connected to Internet 260 through a backbone connection 242. In accordance with a specific embodiment, the server 250 can include programs and drivers through which it can be determined whether a request for information from a device 110 is coming from the service set 221. Being able to make this determination can be useful in assuring that vehicles within area 225 can only be accessed by devices within area 245. For example, an owner of a commercial establishment can provide its customers the ability to monitor their vehicle only when within a designated area, and prevent such access if they are outside this area. Limiting access in this manner can be a useful security feature to keep unauthorized individuals from accessing information about vehicles parked within area 225 from the Internet.

In an alternate embodiment, the server 250 can execute program that interfaces with a service associated with an IP address on the Internet 260 to allow members of a subscription service to access image information through the cameras mounted within their vehicles. In this embodiment it would not be necessary for subscribers to be within a common service set to allow them to monitor their passenger vehicles from anywhere. For example, a subscriber to such a service would be able to park their vehicle at an airport parking facility, i.e., area 225, and be allowed to request and receive image information from the camera within their vehicle while they are traveling through the Internet 260.

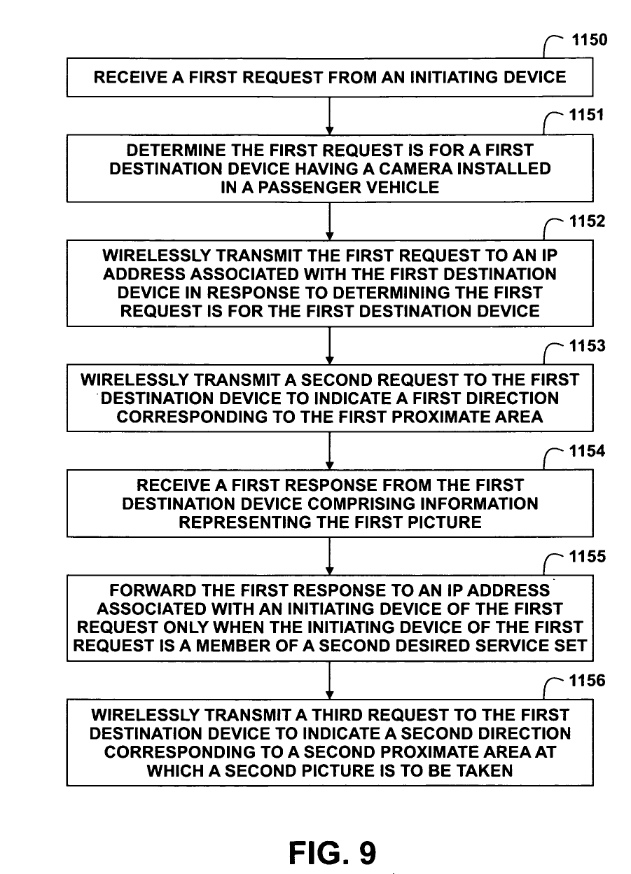

FIG. 9 illustrates, in flow diagram form, a method in accordance with an alternate embodiment of the present disclosure. At step 1150, a first request is received from an initiating device, at a device such as the server 250 of FIG. 8. At 1151, the server 250 can determine if the first request is for a first destination device having a camera installed in the passenger vehicle. Such determination can be made based upon a port ID, or other information provided from the initiating device, to indicate it includes a camera. At 1152, the first request is wirelessly transmitted to an IP address associated with the first destination device when it is determined that the first request is for the first destination device. One example of such a first request would be a request to take a first picture of an area proximate to the first destination device. At 1153, a second request is wirelessly transmitted from the server 250 to the first destination device to indicate a first direction corresponding to the first proximate area. It will be understood that the second request can be transmitted with the first request in a common packet, and that the second request would typically be received by the same destination device as the first request. At 1154, a response is received from the first destination device at the server 250 that include information representing the first picture. In accordance with a specific embodiment, the image information can be a single image, such as a still picture, or one of a plurality of images of a video stream from the camera. At 1155, the first response is forwarded to an IP address associated with an initiating device. At 1156, a third request is wirelessly transmitted to the first destination device, to indicate a second direction corresponding to a second proximate area at which a second picture is to be taken.

It will be appreciated that not all of the activities or examples described in the written description above are required, and that one or more further activities may be performed in addition to those described. Still further, the order in which activities are listed are not necessarily the order in which they are performed. After reading this specification, skilled artisans will be capable of determining what activities can be used for their specific needs or desires.

It will be understood that specific steps disclosed herein may actually be implemented in various combinations of hardware and software. For example, control provided by the server 250 of FIG. 8 can be performed by a hardware engine, by firmware, such as in microcode, executed on the processing engine associated with the controller 426, or it may even be performed fully in software executed on a data processor. Such a data processor may be a single processing device or a plurality of processing devices. Such a processing device may be a microprocessor, microcontroller, digital signal processor, microcomputer, portion of the central processing unit, state machine, logic circuitry, and/or any device that manipulates signals (e.g., analog or digital) based on operational instructions. The memory may be a single memory device or a plurality of memory devices. Such a memory device may be a read-only memory, random access memory, floppy disk memory, magnetic tape memory, erasable memory, portion of system memory, and/or any device that stores operational instructions in a digital format. Note that when the processing module implements one or more of its functions via a state machine or logic circuitry, the memory storing the corresponding operational instructions can be embedded within the circuitry comprising the state machine and/or logic circuitry.

In the foregoing specification, principles of the disclosure have been described in connection with specific embodiments. However, one of ordinary skill in the art appreciates that one or more modifications or one or more other changes can be made to any one or more of the embodiments without departing from the scope of the invention as set forth in the claims below. Accordingly, the specification and figures are to be regarded in an illustrative rather than a restrictive sense and any and all such modifications and other changes are intended to be included within the scope of invention. For example, it will be appreciated that the present disclosure can be readily modified to provide sound in the same manner as video, it will be further appreciated that the areas 225 and 245 illustrated in FIG. 8 can overlap.

Any one or more benefits, one or more other advantages, one or more solutions to one or more problems, or any combination thereof have been described above with regard to one or more specific embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

What is claimed is:

1. A method comprising:
associating a first device comprising a camera installed in a passenger vehicle with a first wireless router; and
receiving an IP address at the first device, wherein the IP address is associated with the first device.

2. The method of claim 1 further comprising:
receiving a first request to control a direction at which an image is to be captured by the camera;
receiving a second request to have the camera capture and provide the image to a second device, wherein the second request is based upon information originated at the second device;
wirelessly transmitting image information representative of the image along with an IP address of second device; and
honoring the request to provide the image only when the second device is a member of the same service set as the first device.

3. The method of claim 1 further comprising:
registering the first device with a subscription service at a defined IP address subsequent to receiving the IP address;
receiving a first request to control a direction at which an image is to be captured by the camera;
receiving a second request to have the camera capture and provide the image; and
honoring the second request to provide the image only if registering has occurred, wherein honoring includes wirelessly transmitting image information representing the image from the first device to a destination address.

4. The method of claim 1 wherein honoring the second request further comprises wirelessly transmitting an IP address of the first wireless router along with the image information.

5. The method of claim 1 further comprising:
receiving first information comprising a request for an image to be provided from the camera to a second device.

6. The method of claim 5 further comprising:
wirelessly transmitting image information representative of the image along with an IP address of the first wireless router.

7. The method of claim 5 wherein the first information is based upon information originated at the second device.

8. The method of claim 5 further comprising:
receiving second information comprising a request to control a direction at which the image is to be taken.

9. The method of claim 1 further comprising:
registering the IP address received from the wireless router with a subscription service.

10. The method of claim 9 further comprising:
receiving first information comprising a request for an image to be provided from the camera; and
honoring the request for the image only when the first device is a member of the same service set as the device.

11. The method of claim 10 wherein the service set is an extended service set.

12. The method of claim 10 wherein the service set is a basic service set.

13. The method of claim 9 further comprising:
disabling transmission of image information from the camera to a destination address until registering has occurred.

14. The method of claim 13 further comprising:
receiving first information comprising a request for an image to be provided from the camera to a first device; and
honoring the request for the image only when the first information is received from the subscription service.

15. The method of claim 1 further comprises powering the device from a power supply of the passenger vehicle.

16. The method of claim 1 further comprising:
receiving first information comprising a request for an image to be provided from the camera; and
honoring the request for the image only when the first device is a member of the same service set as the device.

17. An apparatus comprising:
a passenger vehicle;
a camera mounted to the passenger vehicle, the camera comprising a communications interface to receive remote requests to obtain and provide information including representations of taken images; and
an IP-based wireless communications controller coupled to the communications interface.

18. The apparatus of claim 17 further comprises a control module coupled to the wireless communications controller to receive remote requests to control a direction at which an image is taken.

19. The apparatus of claim 18 wherein the camera comprises the remote controlled module.

20. A method comprising:
determining a first request is for a first destination device, wherein the first destination device comprises a camera installed in a passenger vehicle;
wirelessly transmitting the first request to an IP address associated with the first destination device in response to determining the first request is for the first destination device, wherein the first request is a request to the first destination device to take a first picture of a first area proximate the first destination device; and
receiving a first response from the first destination device comprising information representing the first picture.
